(19) United States
(12) Patent Application Publication
(10) Pub. No.: US 2013/0096331 A1
(43) Pub. Date: Apr. 18, 2013

(54) INTERESTERIFICATION OF LOW SATURATE SUNFLOWER OIL AND RELATED METHODS AND COMPOSITIONS

(71) Applicant: Dow AgroSciences LLC, Indianapolis, IN (US)

(72) Inventors: James Gerdes, Breckenridge, MN (US); Thomas G. Patterson, Westfield, IN (US); Joshua Flook, Tipton, IN (US)

(73) Assignee: DOW AGROSCIENCES LLC, Indianapolis, IN (US)

(21) Appl. No.: 13/706,018

(22) Filed: Dec. 5, 2012

Related U.S. Application Data
(63) Continuation-in-part of application No. 12/340,525, filed on Dec. 19, 2008.
Application No. 12/340,525 is a continuation-in-part of application No. 12/340,558, filed on Dec. 19, 2008.
(60) Provisional application No. 61/015,591, filed on Dec. 20, 2007.
(60) Provisional application No. 61/015,591, filed on Dec. 20, 2007.

(51) Int. Cl. C11C 3/10

(52) U.S. Cl. CPC C11C 3/10
USPC 554/169; 435/134; 554/227; 554/223

(57) ABSTRACT

A method of producing a interesterified oil includes providing sunflower oil comprising no more than about 4% total saturated fat and interesterifying the sunflower oil. Another method of producing a interesterified oil includes providing sunflower oil comprising about 3.3% or less total combined palmitic acid (16:0) and stearic acid (18:0), and interesterifying the sunflower oil.

### CROSS-REFERENCE TO RELATED APPLICATIONS

This application claims the benefit, as a Continuation-In-Part application, of the filing dates of U.S. patent application Ser. Nos. 12/340,525 and 12/340,558, both filed Dec. 19, 2008, and each of which claim benefit of the filing date of U.S. Provisional Patent Application, Ser. No. 61/015,591, filed Dec. 20, 2007. The subject matter of the present application is related to U.S. patent application Ser. No. 13/015,236, filed Jan. 27, 2011 and U.S. patent application Ser. No. 13/024,002, filed Feb. 9, 2011.

### FIELD OF THE INVENTION

The present invention relates to interesterified oils from sunflower that is low in saturated fat and, optionally, high in oleic acid, as well as associated methods.

### BACKGROUND OF THE INVENTION

Liquid vegetables oils, such as sunflower oil, require modification to be used as products like vegetable shortenings. The most direct modification involves mixing the oil with a saturated fat that will lead to a blend with varying concentrations of saturated fats. For commercial vegetable shortening blends, the solid fat content, or SFC, is a property that reflects the amount of fat that remains as a solid at a particular temperature. This property influences the performance of the product in specific baking applications (cakes, pastry, etc.). Depending on the product application, higher or lower solid fat contents may be required. The solid fats used may come from blending with natural highly saturated fats (animal fat, palm oil, etc.), fractionated vegetable oils (palm stearin) or the use of fully hydrogenated vegetable oils (palm, cottonseed, soybean, etc.). The content of palmitic and stearic acid in these blends will influence the properties of the shortening, and the formation of fat crystals in the beta or beta prime configuration, which in turn influences the baking and sensory properties.

Another common modification of liquid vegetables oils is the interesterification of the oil with the hard fat source. In interesterification, the fundamental structure of the triglycerides in the blend is altered through either a chemically or enzymatically catalyzed rearrangement of the fatty acids on the triglyceride. Chemically catalyzed interesterification involves the rearrangement of all the fatty acids by chemical rearrangement of the fatty acids. Due to the stereo-specificity of the lipase used in the reaction, enzymatically catalyzed interesterification exchanges only the fatty acids in the 1′ and 3′ position on the triglyceride.

The cultivated sunflower (Helianthus annuus L.) is a major worldwide source of vegetable oil. In the United States, approximately 4 million acres are planted in sunflowers annually, primarily in the Dakotas and Minnesota.

Sunflower oil is comprised primarily of palmitic (16:0), stearic (18:0), oleic (18:1), linoleic (18:2) and linolenic (18:3) acids. While other unusual fatty acids exist in plants, palmitic, stearic, oleic, linoleic, and linolenic acids comprise about 88% of the fatty acids present in the world production of vegetable oils. (Harwood, J. L., Plant Acyl Lipids: Structure, Distribution and Analysis, 4 Lipids: Structure and Function, P. K. Stumpf and E. E. Conn ed. (1988)). Palmitic and stearic acids are saturated fatty acids that have been demonstrated in certain studies to contribute to an increase in the plasma cholesterol level, a factor in coronary heart disease. According to recent studies, vegetable oils high in unsaturated fatty acids, such as oleic and linoleic acids may have the ability to lower plasma cholesterol. Saturated fatty acids also have higher melting points in general than unsaturated fatty acids of the same carbon number, which contributes to cold tolerance problems in foodstuffs and can contribute to a waxy or greasy feel in the mouth during ingestion. It is also known that food products made from fats and oils having less than about 3% saturated fatty acids will typically contain less than 0.5 gram saturated fat per serving and as a result can be labeled as containing “zero saturated fat” under current labeling regulations. Thus, for a number of reasons, it is desirable to produce a sunflower oil having low levels of palmitic and stearic acids and high levels of oleic or linoleic acids.

There are numerous steps in the development of any novel, desirable plant germplasm. Plant breeding begins with the analysis and definition of problems and weaknesses of the current germplasm, the establishment of program goals, and the definition of specific breeding objectives. The next step is selection of germplasm that possess the traits to meet the program goals. The goal is to combine in a single variety an improved combination of desirable traits from the parental germplasm. These important traits may include higher seed yield, resistance to diseases and insects, better stems and roots, tolerance to drought and heat, and better agronomic quality.

Choice of breeding or selection methods depends on the mode of plant reproduction, the heritability of the trait(s) being improved, and the type of cultivar used commercially (e.g., F₁ hybrid cultivar, pureline cultivar, etc.). For highly heritable traits, a choice of superior individual plants evaluated at a single location will be effective, whereas for traits with low heritability, selection should be based on mean values obtained from replicated evaluations of families of related plants. Popular selection methods commonly include pedigree selection, modified pedigree selection, mass selection, and recurrent selection.

Sunflower, Helianthus annuus L., is an important and valuable field crop. Thus, a continuing goal of plant breeders is to develop stable, high yielding sunflower cultivars that are agronomically sound. A current goal is to maximize the amount of grain produced on the land used and to supply food for both animals and humans. To accomplish this goal, the sunflower breeder must select and develop sunflower plants that have traits that result in superior cultivars.

The foregoing examples of the related art and limitations related therewith are intended to be illustrative and not exclusive. Other limitations of the related art will become apparent to those of skill in the art upon a reading of the specification.

### BRIEF SUMMARY OF THE INVENTION

The following embodiments are described in conjunction with systems, tools and methods which are meant to be exemplary and illustrative, and not limiting in scope. In various embodiments, one or more of the above-described problems have been reduced or eliminated, while other embodiments are directed to other improvements.

A particular embodiment of the invention includes a method of producing a interesterified oil, the method comprising providing sunflower oil comprising no more than about 4% total saturated fat, and interesterifying the sunflower oil.

An interesterified oil produced by this method of the invention is also included. In particular embodiments, at least 50% of the fatty acids at the 2 position of glycerol in the oil can consist of unsaturated fatty acids. In other embodiments, at least 50% of the fatty acids at the 2 position of glycerol oil can consist of oleic acid. In particular embodiments, the interesterified oil can include sunflower oil.

Another embodiment of the invention includes a method of producing a interesterified oil, the method comprising providing sunflower oil comprising about 3.3% or less total combined palmitic acid (16:0) and stearic acid (18:0), and interesterifying the sunflower oil. An interesterified oil produced by this method of the invention are also included.

According to the invention, there is provided a novel sunflower plant producing seeds having low saturated fat content. This invention, in part, relates to the seeds of sunflower having low saturated fat content, to the plants or plant parts, of sunflower plants producing seeds having low saturated fat content, and to methods for producing a sunflower plant produced by crossing the sunflower plants producing seeds having low saturated fat content with itself or another sunflower cultivar, and the creation of variants by mutagenesis or transformation of sunflower plants producing seeds having low saturated fat content.

Aspects of the invention provide use of novel sunflower plants producing seeds having low saturated fat content and high oleic acid content used to produce interesterified oil. This invention, in part, relates to the seeds of sunflower having low saturated fat content and high oleic acid content.

Examples of seeds having low saturated fat content include, but are not limited to, seeds having about 2.8% or less, about 2.9% or less, about 3% or less, about 3.1% or less, about 3.2% or less, or about 3.3% or less total combined palmitic acid (16:0) and stearic acid (18:0) content for use in production of interesterified sunflower oil.

Examples of seeds of having low saturated fat content and high oleic acid (18:1) content include, but are not limited to, seeds having about 4.1% or less, about 5% or less, about 6 or less, about 7% or less, about 8% or less, about 9% or less, about 10% or less, about 11% or less, or about 12% or less total combined palmitic acids (16:0) and stearic acid (18:0) content and having about 88% to 100% (including percent integers therebetween) oleic acid (18:1).

In addition to the exemplary aspects and embodiments described above, further aspects and embodiments will become apparent by study of the following descriptions.

### DETAILED DESCRIPTION OF THE INVENTION

In the description and tables which follow, a number of terms are used. In order to provide a clear and consistent understanding of the specification and claims, including the scope to be given such terms, the following definitions are provided:

Allele. Allele is any of one or more alternative forms of a gene, all of which alleles relate to one trait or characteristic. In a diploid cell or organism, the two alleles of a given gene occupy corresponding loci on a pair of homologous chromosomes.

Backcrossing. Backcrossing is a process in which a breeder repeatedly crosses hybrid progeny back to one of the parents, for example, a first generation hybrid F₁ with one of the parental genotypes of the F₁ hybrid.

Elite sunflower. A sunflower cultivar which has been stabilized for certain commercially important agronomic traits comprising a stabilized yield of about 100% or greater relative to the yield of check varieties in the same growing location growing at the same time and under the same conditions. In one embodiment, “elite sunflower” means a sunflower cultivar stabilized for certain commercially important agronomic traits comprising a stabilized yield of 110% or greater relative to the yield of check varieties in the same growing location growing at the same time and under the same conditions. In another embodiment, “elite sunflower” means a sunflower cultivar stabilized for certain commercially important agronomic traits comprising a stabilized yield of 115% or greater relative to the yield of check varieties in the same growing location growing at the same time and under the same conditions.

Embryo. The embryo is the small plant contained within a mature seed.

FAME analysis. Fatty Acid Methyl Ester analysis is a method that allows for accurate quantification of the fatty acids that make up complex lipid classes.

Mutagenesis. Mutagenesis refers to mutagenesis of a plant or plant part with a mutagen (e.g., a chemical or physical agent that increases the frequency of mutations in a target plant or plant part). By way of non-limiting example, the double chemical mutagenesis technique of Konzak, as described in U.S. Pat. No. 6,696, (the disclosure of which is incorporated by reference herein), can be used to induce mutant alleles in endogenous plant genes.

Oil content. This is measured as percent of the whole dried seed and is characteristic of different varieties. It can be determined using various analytical techniques such as NMR, NIR, and Soxhlet extraction.

Percentage of total fatty acids. This is determined by extracting a sample of oil from seed, producing the methyl esters of fatty acids present in that oil sample and analyzing the proportions of the various fatty acids in the sample using gas chromatography. The fatty acid composition can also be a distinguishing characteristic of a variety.

Single Gene Converted (Conversion). Single gene converted (conversion) plant refers to plants which are developed by a plant breeding technique called backcrossing, or via genetic engineering, wherein essentially all of the desired morphological and physiological characteristics of a variety are recovered in addition to the single gene transferred into the variety via the backcrossing technique or via genetic engineering.

Stabilized. Reproducibly passed from one generation to the next generation of inbred plants of same variety.

Total Saturated (TOTSAT). Total percent oil of the seed of the saturated fats in the oil including C12:0, C 14:0, C16:0, C18:0, C20:0, C22:0 and C24.0.

According to a particular embodiment the invention, there is provided a novel sunflower plant producing seeds having low saturated fat content that can be used for interesterification. This embodiment relates to the seeds of sunflower having low saturated fat content, to the plants, or plant parts, of sunflower plants producing seeds having low saturated fat content, and to methods for producing a sunflower plant produced by crossing the sunflower plant producing seeds having low saturated fat content with itself or another sunflower cultivar, and the creation of variants by mutagenesis or transformation of sunflower plants producing seeds having low saturated fat content.

Other aspects of the invention provide novel sunflower plants producing seeds having low saturated fat content and high oleic acid content that can be used for interesterification. One embodiment relates to the seeds of sunflower having low saturated fat content and high oleic acid content, to the plants, or plant parts, of sunflower plants producing seeds having low saturated fat content and high oleic acid content, and to methods for producing a sunflower plant produced by crossing the sunflower plants producing seeds having low saturated fat content and high oleic acid content with itself or another sunflower cultivar, and the creation of variants by mutagenesis or transformation of sunflower plants producing seeds having low saturated fat content and high oleic acid content.

Examples of seeds having low saturated fat content include, but are not limited to, seeds having about 2.8% or less, about 2.9% or less, about 3% or less, about 3.1% or less, about 3.2% or less, or about 3.3% or less total combined palmitic acid (16:0) and stearic acid (18:0) content.

Examples of seeds of having low saturated fat content and high oleic acid (18:1) content include, but are not limited to, seeds having about 6% or less, about 4.1% or less, about 5% or less, about 6% or less, about 7% or less, about 8% or less, about 9% or less, about 10% or less, about 11% or less, or about 12% or less total combined palmitic acids (16:0) and stearic acid (18:0) content, and having about 88% to 100% (including percent integers therebetween) oleic acid (18:1).

Thus, any such methods using the sunflower plants producing seeds having low saturated fat and, optionally, high oleic acid content, are part of this invention (e.g., selfing, backcrosses, hybrid production, crosses to populations, and the like). All plants produced using sunflower plants that produce seeds having as a parent low saturated fat and, optionally, high oleic acid content, are within the scope of this invention. Advantageously, the sunflower plant could be used in crosses with other, different, sunflower plants to produce first generation (F₁) sunflower hybrid seeds and plants with superior characteristics.

In another aspect, the present invention provides for single or multiple gene converted sunflower plants producing seeds having low saturated fat and, optionally, high oleic acid content. The transferred gene(s) may preferably be a dominant or recessive allele. Preferably, the transferred gene(s) will confer such traits as herbicide resistance, insect resistance, bacterial resistance, fungal resistance, viral disease resistance, male fertility, male sterility, enhanced nutritional quality, and industrial usage. The gene may be a naturally occurring sunflower gene or a transgene introduced through genetic engineering techniques.

In another aspect, the present invention provides regenerable cells for use in tissue culture of sunflower plants producing seeds having low saturated fat and, optionally, high oleic acid content. The tissue culture will preferably be capable of regenerating plants having the physiological and morphological characteristics of the foregoing sunflower plant producing seeds having low saturated fat and, optionally, high oleic acid content, and of regenerating plants having substantially the same genotype as the foregoing sunflower plant. The regenerable cells in such tissue cultures can be embryos, protoplasts, meristematic cells, callus, pollen, leaves, anthers, roots, root tips, flowers, seeds, pods or stems. Still further, an embodiment of the invention provides sunflower plants regenerated from the tissue cultures of the invention.

In another aspect, the present invention provides a method of introducing a desired trait into sunflower plants producing seeds having low saturated fat and, optionally, high oleic acid content, wherein the method comprises: crossing a sunflower plant that produces seeds having low saturated fat and, optionally, high oleic acid content with a plant of another sunflower cultivar that comprises a desired trait to produce F₁ progeny plants; selecting one or more progeny plants that have the desired trait to produce selected progeny plants; crossing the selected progeny plants with the sunflower plants producing seeds having low saturated fat and, optionally, high oleic acid content to produce backcross progeny plants; selecting for backcross progeny plants that have the desired trait and physiological and morphological characteristics of sunflower plants that produce seeds having low saturated fat and, optionally, high oleic acid content to produce elected backcross progeny plants; and repeating these steps to produce selected first or higher backcross progeny plants that comprise the desired trait and all of the physiological and morphological characteristics of sunflower plants producing seeds having low saturated fat and, optionally, high oleic acid content.

Useful methods include, but are not limited to, expression vectors introduced into plant tissues using a direct gene transfer method such as microprojectile-mediated delivery, DNA injection, electroporation and the like. Expression vectors can be introduced into plant tissues using the microprojectile media delivery with the biolistic device Agrobacterium-mediated transformation. Transformant plants obtained with the protoplasm of the invention are intended to be within the scope of this invention.

Plant transformation involves the construction of an expression vector which will function in plant cells. Such a vector comprises DNA that includes a gene under control of or operatively linked to a regulatory element (for example, a promoter). The expression vector may contain one or more such operably linked gene/regulatory element combinations. The vector(s) may be in the form of a plasmid and can be used alone or in combination with other plasmids to provide transformed sunflower plants using transformation methods as described below to incorporate transgenes into the genetic material of the sunflower plant(s).

### Expression Vectors for Sunflower Transformation: Marker Genes

Expression vectors include at least one genetic marker, operably linked to a regulatory element (a promoter, for example) that allows transformed cells containing the marker to be either recovered by negative selection (i.e., inhibiting growth of cells that do not contain the selectable marker gene) or by positive selection (i.e., screening for the product encoded by the genetic marker). Many commonly used selectable marker genes for plant transformation are well known in the transformation arts and include, for example, genes that code for enzymes that metabolically detoxify a selective chemical agent which may be an antibiotic or an herbicide, or genes that encode an altered target which is insensitive to the inhibitor. A few positive selection methods are also known in the art.

One commonly used selectable marker gene for plant transformation is the neomycin phosphotransferase II (nptII) gene under the control of plant regulatory signals, which confers resistance to kanamycin. See, e.g., Fraley et al., Proc. Natl. Acad. Sci. U.S.A., 80:4803 (1983). Another commonly used selectable marker gene is the hygromycin phosphotransferase gene which confers resistance to the antibiotic hygromycin. See, e.g., Vanden Elzen et al., Plant Mol. Biol., 5:299 (1985).

Additional selectable marker genes of bacterial origin that confer resistance to antibiotics include gentamycin acetyl transferase, streptomycin phosphotransferase, aminoglycoside-3′-adenyl transferase and the bleomycin resistance determinant. See Hayford et al., Plant Physiol. 86:1216 (1988), Jones et al., Mol. Gen. Genet., 210:86 (1987), Svab et al., Plant Mol. Biol. 14:197 (1990), Hille et al., Plant Mol. Biol. 7:171 (1986). Other selectable marker genes confer resistance to herbicides such as glyphosate, glufosinate or bromoxynil. See Comai et al., Nature 317:741-744 (1985), Gordon-Kamm et al., Plant Cell 2:603-618 (1990) and Stalker et al., Science 242:419-423 (1988).

Other selectable marker genes for plant transformation are not of bacterial origin. These genes include, for example, mouse dihydrofolate reductase, plant 5-enolpyruvylshikimate-3-phosphate synthase and plant acetolactate synthase. See Eichholtz et al., Somatic Cell Mol. Genet. 13:67 (1987), Shah et al., Science 233:478 (1986), Charest et al., Plant Cell Rep. 8:643 (1990).

Another class of marker genes for plant transformation requires screening of presumptively transformed plant cells rather than direct genetic selection of transformed cells for resistance to a toxic substance, such as an antibiotic. These genes are particularly useful to quantify or visualize the spatial pattern of expression of a gene in specific tissues and are frequently referred to as reporter genes because they can be fused to a gene or gene regulatory sequence for the investigation of gene expression. Commonly used genes for screening presumptively transformed cells include β-glucuronidase (GUS), β-galactosidase, luciferase and chloramphenicol acetyltransferase. See Jefferson, R. A., Plant Mol. Biol. Rep. 5:387 (1987), Teen et al., EMBO J. 8:343 (1989), Koncz et al., Proc. Natl. Acad. Sci U.S.A. 84:131 (1987), DeBlock et al., EMBO J. 3:1681 (1984).

Recently, in vivo methods for visualizing GUS activity that do not require destruction of plant tissue have been made available. Molecular Probes publication 2908, Imagene Green™, p. 1-4(1993) and Naleway et al., J. Cell Biol. 115:151a (1991). However, these in vivo methods for visualizing GUS activity have not proven useful for recovery of transformed cells because of low sensitivity, high fluorescent backgrounds and limitations associated with the use of luciferase genes as selectable markers.

More recently, a gene encoding Green Fluorescent Protein (GFP) has been utilized as a marker for gene expression in prokaryotic and eukaryotic cells. See Chalfie et al., Science 263:802 (1994). GFP and mutants of GFP may be used as screenable markers.

### Expression Vectors for Sunflower Transformation: Promoters

Genes included in expression vectors must be driven by a nucleotide sequence comprising a regulatory element, for example, a promoter. Several types of promoters are now well known in the transformation arts, as are other regulatory elements that can be used alone or in combination with promoters.

As used herein, “promoter” includes reference to a region of DNA that is upstream from the start of transcription and that is involved in recognition and binding of RNA polymerase and other proteins to initiate transcription. A “plant promoter” is a promoter capable of initiating transcription in plant cells. Examples of promoters under developmental control include promoters that preferentially initiate transcription in certain tissues, such as leaves, roots, seeds, fibers, xylem vessels, tracheids, or sclerenchyma. Such promoters are referred to as “tissue-preferred”. Promoters which initiate transcription only in certain tissues are referred to as “tissue-specific”. A “cell type” specific promoter primarily drives expression in certain cell types in one or more organs, for example, vascular cells in roots or leaves. An “inducible” promoter is a promoter which is under environmental control. Examples of environmental conditions that may effect transcription by inducible promoters include anaerobic conditions or the presence of light. Tissue-specific, tissue-preferred, cell type specific, and inducible promoters constitute the class of “non-constitutive” promoters. A “constitutive” promoter is a promoter which is active under most environmental conditions.

Methods for Sunflower Transformation

Numerous methods for plant transformation have been developed, including biological and physical plant transformation protocols. See, for example, Miki et al., “Procedures for Introducing Foreign DNA into Plants” in Methods in Plant Molecular Biology and Biotechnology, Glick B. R. and Thompson, J. E. Eds. (CRC Press, Inc., Boca Raton, 1993) pages 67-88. In addition, expression vectors and in vitro culture methods for plant cell or tissue transformation and regeneration of plants are available. See, e.g., Gruber et al., “Vectors for Plant Transformation” in Methods in Plant Molecular Biology and Biotechnology, Glick B. R. and Thompson, J. E. Eds. (CRC Press, Inc., Boca Raton, 1993) pages 89-119.

A) Agrobacterium-mediated Transformation—One method for introducing an expression vector into plants is based on the natural transformation system of Agrobacterium. See, e.g., Horsch et al., Science 227:1229 (1985). A. tumefaciens and A. rhizogenes are plant pathogenic soil bacteria which genetically transform plant cells. The Ti and Ri plasmids of A. tumefaciens and A. rhizogenes, respectively, carry genes responsible for genetic transformation of the plant. See, for example, Kado, C. I., Crit. Rev. Plant Sci. 10:1 (1991). Descriptions of Agrobacterium vector systems and methods for Agrobacterium-mediated gene transfer are provided by Gruber et al., supra, Mild et al., supra, and Moloney et al., Plant Cell Reports 8:238 (1989). See also, U.S. Pat. No. 5,563,055 (Townsend and Thomas), issued Oct. 8, 1996.

B) Direct Gene Transfer—Several methods of plant transformation, collectively referred to as direct gene transfer, have been developed as an alternative to Agrobacterium-mediated transformation. A generally applicable method of plant transformation is microprojectile-mediated transformation wherein DNA is carried on the surface of microprojectiles measuring 1 to 4 μm. The expression vector is introduced into plant tissues with a biolistic device that accelerates the microprojectiles to speeds of 300 to 600 m/s which is sufficient to penetrate plant cell walls and membranes. Sanford et al., Part. Sci. Technol. 5:27 (1987), Sanford, J. C., Trends Biotech. 6:299 (1988), Klein et al., Bio/Technology 6:559-563 (1988), Sanford, J. C., Physiol Plant 7:206 (1990), Klein et al., Biotechnology 10:268 (1992). See also U.S. Pat. No. 5,015,580 (Christou, et al.), issued May 14, 1991; U.S. Pat. No. 5,322,783 (Tomes, et al.), issued Jun. 21, 1994.

Another method for physical delivery of DNA to plants is sonication of target cells. Zhang et al., Bio/Technology 9:996 (1991). Alternatively, liposome and spheroplast fusion have been used to introduce expression vectors into plants. Deshayes et al., EMBO J, 4:2731 (1985), Christou et al., Proc Natl. Acad. Sci. U.S.A. 84:3962 (1987). Direct uptake of DNA into protoplasts using CaCl₂ precipitation, polyvinyl alcohol or poly-L-ornithine has also been reported. Hain et al., Mol. Gen. Genet. 199:161 (1985) and Draper et al., Plant Cell Physiol. 23:451 (1982). Electroporation of protoplasts and whole cells and tissues have also been described. Donn et al., In Abstracts of VIIth International Congress on Plant Cell and Tissue Culture IAPTC, A2-38, p 53 (1990); D'Halluin et al., Plant Cell 4:1495-1505 (1992) and Spencer et al., Plant Mol. Biol. 24:51-61 (1994).

Following transformation of sunflower target tissues, expression of the above-described selectable marker genes allows for preferential selection of transformed cells, tissues and/or plants, using regeneration and selection methods well known in the art.

The foregoing methods for transformation would typically be used for producing a transgenic variety. The transgenic variety can then be crossed, with another (non-transformed or transformed) variety, in order to produce a new transgenic variety. Alternatively, a genetic trait which has been engineered into a particular sunflower cultivar using the foregoing transformation techniques can be moved into another cultivar using traditional backcrossing techniques that are well known in the plant breeding arts. For example, a backcrossing approach can be used to move an engineered trait from a public, non-elite variety into an elite variety, or from a variety containing a foreign gene in its genome into a variety or varieties which do not contain that gene. As used herein, “crossing” can refer to a simple X by Y cross, or the process of backcrossing, depending on the context.

### Tissue Culture of Sunflowers

Further production of a sunflower plant producing seeds having low saturated fat and, optionally, high oleic acid content can occur by self-pollination or by tissue culture and regeneration. Tissue culture of various tissues of sunflower and regeneration of plants therefrom is known. For example, the propagation of a sunflower cultivar by tissue culture is described in U.S. Pat. No. 6,998, 516.

Further reproduction of the variety can occur by tissue culture and regeneration. Tissue culture of various tissues of soybeans and regeneration of plants therefrom is well known and widely published. For example, reference may be had to U.S. Pat. No. 6,998, 516, which is incorporated herein in its entirety by reference. Thus, another aspect of this invention is to provide cells, which upon growth and differentiation, produce a sunflower plant having glyphosate resistance and/or produce seeds having low saturated fat and, optionally, high oleic acid content.

As used herein, the term “tissue culture” indicates a composition comprising isolated cells of the same or a different type, or a collection of such cells organized into parts of a plant. Exemplary types of tissue cultures include protoplasts, calli, plant clumps, and plant cells that can generate tissue culture that are intact in plants or parts of plants, such as embryos, pollen, flowers, seeds, pods, leaves, stems, roots, root tips, anthers, and the like. Means for preparing and maintaining plant tissue culture are well known in the art. By way of example, a tissue culture comprising organs has been used to produce regenerated plants. U.S. Pat. Nos. 5,959,185, 5,973,234 5,977,445, and 6,998, 51 describe certain techniques, the disclosures of which are incorporated herein by reference.

### Single-Gene Converted (Conversion) Plants

When the term “sunflower plant” is used in the context of the present invention, this also includes any single gene conversions of that variety. The term “single gene converted plant” as used herein refers to those sunflower plants which are developed by a plant breeding technique called backcrossing, or via genetic engineering, wherein essentially all of the desired morphological and physiological characteristics of a variety are recovered in addition to the single gene transferred into the variety via the backcrossing technique. Backcrossing methods can be used with the present invention to improve or introduce a characteristic into the variety. The teini “backcrossing” as used herein refers to the repeated crossing of a hybrid progeny back to the recurrent parent (i.e., backcrossing 1, 2, 3, 4, 5, 6, 7, 8 or more times to the recurrent parent). The parental sunflower plant, which contributes the gene for the desired characteristic, is termed the “nonrecurrent” or “donor parent”. This terminology refers to the fact that the nonrecurrent parent is used one time in the backcross protocol and therefore does not recur. The parental sunflower plant to which the gene or genes from the nonrecurrent parent are transferred is known as the recurrent parent as it is used for several rounds in the backcrossing protocol (Poehlman & Sleper, 1994; Fehr, 1987). In a typical backcross protocol, the original variety of interest (recurrent parent) is crossed to a second variety (nonrecurrent parent) that carries the single gene of interest to be transferred. The resulting progeny from this cross are then crossed again to the recurrent parent and the process is repeated until a sunflower plant is obtained wherein essentially all of the desired morphological and physiological characteristics of the recurrent parent are recovered in the converted plant, in addition to the single transferred gene from the nonrecurrent parent.

The selection of a suitable recurrent parent is an important step for a successful backcrossing procedure. The goal of a backcross protocol is to alter or substitute a single trait or characteristic in the original variety. To accomplish this, a single gene of the recurrent variety is modified or substituted with the desired gene from the nonrecurrent parent, while retaining essentially all of the rest of the desired genetic and, therefore, the desired physiological and morphological constitution of the original variety. The choice of the particular nonrecurrent parent will depend on the purpose of the backcross. One of the major purposes is to add some commercially desirable, agronomically important trait to the plant. The exact backcrossing protocol will depend on the characteristic or trait being altered to determine an appropriate testing protocol. Although backcrossing methods are simplified when the characteristic being transferred is a dominant allele, a recessive allele may also be transferred. In this instance it may be necessary to introduce a test of the progeny to determine if the desired characteristic has been successfully transferred.

Many single gene traits have been identified that are not regularly selected for in the development of a new variety but that can be improved by backcrossing techniques. Single gene traits may or may not be transgenic, examples of these traits include but are not limited to, male sterility, waxy starch, herbicide resistance, resistance for bacterial, fungal, or viral disease, insect resistance, male fertility, enhanced nutritional quality, industrial usage, yield stability and yield enhancement. These genes are generally inherited through the nucleus. Several of these single gene traits are described in U.S. Pat. Nos. 5,959,185, 5,973,234 and 5,977,445, the disclosures of which are hereby incorporated by reference.

### Interesterification

According to embodiments of the invention, seed oils described herein may by interesterified. In certain embodiments, the seed oil to be interesterified may be a sunflower oil comprising about 4% or less saturated fat. In particular embodiments, the seed oil to be interesterified may be sunflower oil comprising about 3% or less palmitic acid (16:0) and/or at least about 90% oleic acid (18:1).

In other embodiments, interesterification of oil may be performed by any method known in the art. (See, e.g., Siew et al., Physical properties of lipase-catalyzed interesterification of palm stearin with canola oil blends, Eur. J. Lipid Sci. Technol. 109 (2007) 97-106; Chu et al., Comparison of Lipase-Transesterified Blen with Some Commercial Solid Frying Shortenings in Malasia, JOACS, Vol. 78, no. 12 (2001), 1213-1219; Ahmadi et al., Chemical and enzymatic interesterification of tristearin/triolein-rich blends: Chemical composition, solid fat content and thermal properties, Eur. J. Lipid Sci. Technol. 110 (2008) 1014-1024, the contents of each of which is incorporated by reference herein. Suitable methods include, for example, heat, chemical, and/or enzymatic interesterification. In certain embodiments, esterification may be carried out in the absence of chemical or enzymatic catalysis. By way of non-limiting example, interesterification of oil may be carried out by heating the oil and allowing interesterification to proceed. In certain embodiments, the oil may be heated to a temperature of from about 100 to about 200 degrees Celsius. In further embodiments, the heated oil may be kept at such temperatures as long as required to achieve a desired proportion of interesterification. In further embodiments, the temperature of the oil may be cycled through a range of temperature to promote interesterification while minimizing unwanted side reactions.

In some embodiments, interesterification may be performed with the aid of a chemical catalyst. Examples of chemical catalysts include, but are not limited to, alkali metals (e.g. sodium and potassium), alkali metal alkylates, alkali metal hydroxides, alkali metal alcoholates (alkoxides), alkali metal alloys (e.g. Na/K alloys) sodium methoxide, sodium ethoxide, and sodium stearate. In certain embodiments, the chemical catalyst may be present in the oils in proportions of from about 0.01% to about 0.5% catalyst by weight. In other embodiments, the oil may be heated to a temperature of from about 50 to about 120 degrees Celsius before or after the addition of the catalyst to the oil. In the case where Na/K alloys are used as catalysts, the oil may be kept at about 50 degrees Celsius or less. In further embodiments, the heated oil may be kept at temperatures as sufficiently high and for a duration of time necessary to achieve a desired proportion of interesterification. In further embodiments, the temperature of the oil may be cycled through a range of temperatures (e.g. to promote interesterification while minimizing unwanted side reactions).

In alternative embodiments, interesterification may be performed with the aid of an enzymatic catalyst. One non-limiting example of such an enzymatic catalyst is a lipase. In certain embodiments, the lipase may be selected for fatty acids at different positions on the glycerol backbone or for particular fatty acids. For example, the lipase may be a 1,3 lipase, which only catalyzes the interesterification of fatty acids at the 1 and 3 positions of glycerol. Examples of lipases useful in interesterification reactions include, but are not limited to, Lipozyme RM IM (Rhizomucor miehie lipase immobilized onto a weak anion exchange resin), Lipozyme TL IM, Pseudomonas sp. lipases, Rhizopus delemar lipase, and Lipozyme IM-60. In other embodiments, the lipase may be immobilized or present in solution with the oil. In further embodiments, the heated oil may be kept in the presence of the enzymatic catalyst as long as required so as to achieve a desired proportion of interesterification. In yet other embodiments, the oil may be kept at a temperature of about 70 degrees Celsius or less before or after the addition of the catalyst to the oil. In additional embodiments, a base may be added to the oil to aid with interesterification.

In some embodiments, a sunflower oil comprising at least about 90% oleic acid (18:1) is interesterified using a 1,3 specific lipase. As the sunflower oil contains such a high proportion of oleic acid, the majority of triglycerides will contain oleic acid in the 2 position of the triglyceride. With interesterification using a 1,3 specific lipase, this fatty acid should remain in the 2 position, while the fatty acids in the 1 and 3 positions are exchanged. It is thus expected that using high content oleic acid sunflower oil will result in a higher proportion of the interesterified triglycerides having an unsaturated fatty acid in the 2 position than that which would be present in the interesterified product of a wild-type sunflower oil. Embodiments of the invention include interesterified sunflower oils wherein at least 50%, 55%, 60%, 65%, 70%, 75%, 80%, 85%, or 90% of the fatty acids at the 2 position of glycerol are unsaturated. Further embodiments of the invention include interesterified sunflower oils wherein at least 50%, 55%, 60%, 65%, 70%, 75%, 80%, 85%, or 90% of the fatty acids at the 2 position of glycerol are oleic acid (18:1).

In further embodiments, it is contemplated that heat and chemical and enzymatic catalysts may be used singly, in any order sequentially, or in any combination or sequence of combinations.

With the very high oleic acid content of the low saturate sunflower oil of the present invention, a high proportion of the triglycerides will contain oleic acid in the 2′ position of the triglyceride. With enzymatic interesterification, this fatty acid remains in the 2′ position, while the fatty acids in the 1′ and 3′ position are exchanged. Using high oleic low sat oil can result in a higher proportion of the interesterified triglycerides with an unsaturated fatty acid in the 2′ position.

Due to the unique fatty acid composition of the DAS high oleic low saturate sunflower oil, it is expected that interesterified blends may result in novel triglyceride compositions relative to other vegetable oils, resulting in unique product applications in the food industry.

### Oil Blends

In particular embodiments of the invention, oils and interesterified oils as described herein may be used as a base stock for the preparation of shortenings and blends. Typically, liquid vegetable oils such as sunflower oil require modification to be used as products like vegetable shortening. In one embodiment, the sunflower oils and interesterified oils described herein may be mixed with a saturated fat that will lead to a blend with varying concentrations of saturated fats. In other embodiments, the amount and type of saturated fat to be added may be modified so as to achieve a specific solid fat content. In embodiments, the final solid fat content may be based upon a particular desired product application (e.g. pastry, cakes, etc.). Embodiments of the invention include saturated fats that may come from or be added as a part of any highly saturated fat composition, such as, but not limited to, animal fats, palm oil, fractionated vegetable oils (e.g. palm stearin), or fully hydrogenated vegetable oils (e.g., palm, cottonseed, soybean, etc.). The content of palmitic and stearic acids in these blends may influence the properties of the resulting mixture as well as the formation of fat crystals in the beta or beta prime configurations, which in turn influence the baking and sensory properties.

### EXAMPLES

The present invention is further described in the following examples, which are offered by way of illustration and are not intended to limit the invention in any manner.

### Example 1

### Sunflowers Producing Seeds Having Low Saturated Fat Content

Sunflower germplasm with unusually low saturate levels has been developed through normal breeding techniques. Seed oil content of sunflower cultivars are provided in Table 1.

TABLE 1

| | | | | | | TOTAL | C16:0 + |
|---|---|---|---|---|---|---|---|
| Sample | C16:0 | C16:1 | C18:0 | C18:1 | C18:2 | SATS | C18:0 |
| H757B/LS10670B- | 2.34 | 0.09 | 0.48 | 94.18 | 1.51 | 3.39 | 2.82 |
| B-17-3-23.06 | | | | | | | |
| H757B/LS10670B- | 2.47 | 0.11 | 0.51 | 93.62 | 2.11 | 3.42 | 2.98 |
| B-17-3-33.11 | | | | | | | |
| H757B/LS10670B- | 2.24 | 0.09 | 0.53 | 94.25 | 1.49 | 3.45 | 2.77 |
| B-17-3-23.04 | | | | | | | |
| H757B/LS10670B- | 2.70 | 0.13 | 0.50 | 93.26 | 2.24 | 3.67 | 3.2 |
| B-17-3-02.08 | | | | | | | |
| H757B/LS10670B- | 2.45 | 0.11 | 0.54 | 93.62 | 1.73 | 3.68 | 2.99 |
| B-17-3-18.21 | | | | | | | |
| HE06EE010716.001 | 2.17 | 0.11 | 0.82 | 94.29 | 1.41 | 3.63 | 2.99 |
| HE06EE010834.002 | 2.31 | 0.11 | 0.65 | 94.74 | 0.82 | 3.68 | 2.95 |
| HE06EE010746.002 | 2.40 | 0.11 | 0.72 | 93.87 | 1.03 | 3.68 | 3.12 |
| HE06EE010700.003 | 2.48 | 0.13 | 0.57 | 93.46 | 1.78 | 3.78 | 3.05 |
| HE06EE016032.005 | 2.42 | 0.10 | 0.64 | 92.86 | 1.82 | 3.82 | 3.06 |
| HE06EE016037.005 | 2.25 | 0.08 | 0.75 | 93.06 | 1.71 | 3.86 | 3.00 |
| HE06EE016032.002 | 2.40 | 0.10 | 0.70 | 93.00 | 1.72 | 3.87 | 3.09 |
| HE06EE010717.002 | 2.44 | 0.10 | 0.82 | 89.76 | 5.51 | 3.88 | 3.26 |
| HE06EE010695.001 | 2.48 | 0.12 | 0.66 | 91.93 | 3.20 | 3.88 | 3.14 |
| HE06EE010816.002 | 2.34 | 0.12 | 0.88 | 94.10 | 1.24 | 3.88 | 3.22 |
| HE06EE010700.001 | 2.48 | 0.14 | 0.65 | 94.31 | 0.89 | 3.90 | 3.13 |
| HE06EE010814.002 | 2.46 | 0.10 | 0.79 | 94.11 | 1.19 | 3.91 | 3.24 |
| HE06EE010760.004 | 2.54 | 0.11 | 0.63 | 94.07 | 1.16 | 3.92 | 3.16 |
| HE06EE010741.003 | 2.34 | 0.11 | 0.93 | 94.51 | 0.73 | 3.93 | 3.26 |
| HE06EE010737.003 | 2.33 | 0.13 | 0.96 | 93.53 | 1.12 | 3.93 | 3.29 |
| HE06EE016050.005 | 2.41 | 0.08 | 0.73 | 92.57 | 2.67 | 3.94 | 3.13 |
| HE06EE016032.004 | 2.44 | 0.11 | 0.63 | 92.49 | 1.80 | 3.94 | 3.07 |
| HE06EE010763.002 | 2.43 | 0.11 | 0.78 | 94.28 | 0.98 | 3.94 | 3.21 |
| HE06EE010829.002 | 2.53 | 0.13 | 0.70 | 93.26 | 1.84 | 3.95 | 3.23 |
| HE06EE010738.002 | 2.78 | 0.15 | 0.62 | 89.75 | 5.22 | 3.96 | 3.40 |
| HE06EE010741.004 | 2.42 | 0.11 | 0.88 | 94.10 | 0.61 | 3.96 | 3.30 |
| HE06EE010824.004 | 2.35 | 0.10 | 0.80 | 94.14 | 1.15 | 3.97 | 3.15 |
| HE06EE010745.003 | 2.81 | 0.11 | 0.68 | 88.66 | 6.32 | 3.98 | 3.48 |
| HE06EE010816.001 | 2.52 | 0.11 | 0.80 | 91.45 | 3.77 | 3.98 | 3.32 |

### Example 2

### Enzymatic Interesterification of Sunflower Seed Oil

In particular embodiments, sunflower fats and oils can be enzymatically interesterified according to the following process:

| Step | Action |
|---|---|
| 5.1. | Tare out the round bottom flask on a balance |
| 5.2. | Add the desired amount of each oil or fat to be blended (Note: Due to |
| | pretreatment of lipozyme TL IM, will need about 5 times the amount of |
| | oil/fat to be blended. |
| 5.3. | Add 4.2 wt % Lipozyme TL IM to the oil |
| 5.4. | Place the flask in a refining/bleaching apparatus |
| 5.5. | Perform steps 5.6-5.10 to de-aerate the Lipozyme TL IM |
| 5.6. | Set a temperature controller and probe (J-Kem) to 70 degrees C. and begin |
| | gentle agitation |
| 5.7. | Align the T-valve to connect the vacuum line to the flask and pull a vacuum |
| 5.8. | After 15 minutes, break the vacuum with nitrogen by: |
| | 5.6.1 Aligning the T-valve to connect the vacuum line, round bottom |
| | flask, and nitrogen line; |
| | 5.6.2 Open the nitrogen valve on the outside of the fume hood; |
| | 5.6.3 Open the valve next to the pressure regulator inside the fume |
| | hood; |
| | 5.6.4 Turn off the vacuum; |
| | 5.6.5 Open the bleed valve on near the temperature probe to allow |
| | the nitrogen to flow through the system; and |
| | 5.6.6 Align the T-valve to only the nitrogen line and bleaching |
| | vessel are connected |
| 5.9. | Stop the agitation and allow 1-2 minutes for the enzyme to settle |
| 5.10. | Remove the Claisen adapter |
| 5.11. | Perform the steps 5.12-5.17 to dry the Lipozyme TL IM |
| 5.12. | Using the modified pipette withdraw as much of the oil as possible |
| 5.13. | Replace the withdrawn oil with the same amount of fresh oil/fat used in the |
| | de-aeration process |
| 5.14. | Replace the Claisen adapter and begin gentle agitation. J-Kem should still |
| | be kept at 70 C. |
| 5.15. | After 30 minutes stop the agitation and allow 1-2 minutes for the enzyme to |
| | settle |
| 5.16. | Remove the Claisen adapter and using the modified pipette withdraw as |
| | much of the oil as possible |
| 5.17. | Repeat the drying process two more times |
| 5.18. | Perform the steps 5.19 to interesterify the fat/oil blend |
| 5.19. | Replace the withdrawn oil with the fat/oil blend to be esterified |
| 5.20. | Replace the Claisen adapter and begin gentle agitation. J-Kem should still |
| | be set at 70 degrees C. |
| 5.21. | Stop nitrogen blanket and pull vacuum by: |
| | 5.9.1 Aligning the T-valve to connect the vacuum line, round |
| | bottom flask, and nitrogen line; |
| | 5.9.2 Open the vacuum line; |
| | 5.9.3 Close the bleed valve near the temperature probe; |
| | 5.9.4 Close the valve next to the pressure regulator inside the fume |
| | hood; |
| | 5.9.5 Close the nitrogen valve on the outside of the fume hood; and |
| | 5.9.6 Align the T-valve to only the vacuum line and round bottom |
| | vessel are connected |
| 5.22. | After 15 minutes break the vacuum with nitrogen by: |
| | 5.22.1 Aligning the T-valve to connect the vacuum line, round bottom |
| | flask, and nitrogen line; |
| | 5.22.2 Open the nitrogen valve on the outside of the fume hood; |
| | 5.22.3 Open the valve next to the pressure regulator inside the fume |
| | hood; |
| | 5.22.4 Turn off the vacuum; |
| | 5.22.5 Open the bleed valve on near the temperature probe to allow |
| | the nitrogen to flow through the system; and |
| | 5.22.6 Align the T-valve to only the nitrogen line and bleaching |
| | vessel are connected |
| 5.23. | Allow the interesterification reaction to occur overnight (16 to 24 |
| | hours) |
| 5.24. | After the hold time, turn off the J-Kem and stirrer |
| 5.25. | Filter the material using a Buchner funnel, Erlenmeyer with sidearm, |
| | and Whatman #4 filter paper |
| 5.26. | Place the material into an appropriate labeled container and sparge |
| | with nitrogen prior to storage |

### Example 3

### Chemical Interesterification of Sunflower Seed Oil

In particular embodiments, sunflower fats and oils can be chemically interesterified according to the following process:

| Step | Action |
|---|---|
| 5.27. | Tare out the round bottom flask on the balance |
| 5.28. | Add the desired amount of each oil or fat to be blended |
| 5.29. | Place the flask in the refining/bleaching apparatus |
| 5.30. | Set a temperature controller and probe (J-Kem) to 60 degrees C. |
| | and start gentle agitation |
| 5.31. | Pull vacuum on the oil for 15 minutes |
| 5.32. | After 15 minutes break the vacuum with nitrogen by: |
| | 5.6.1 Aligning the T-valve to connect the vacuum line, round |
| | bottom flask, and nitrogen line; |
| | 5.6.2 Open the nitrogen valve on the outside of the fume hood; |
| | 5.6.3 Open the valve next to the pressure regulator inside the fume |
| | hood; |
| | 5.6.7 Turn off the vacuum; |
| | 5.6.8 Open the bleed valve on near the temperature probe to allow |
| | the nitrogen to flow through the system; and |
| | 5.6.9 Align the T-valve to only the nitrogen line and bleaching |
| | vessel are connected |
| 5.33. | Add 0.2-0.3 wt % of sodium methlyate based on oil weight |
| 5.34. | Set the J-Kem to 90 degrees C. |
| 5.35. | Stop nitrogen blanket and pull vacuum by: |
| | 5.9.7 Aligning the T-valve to connect the vacuum line, round |
| | bottom flask, and nitrogen line; |
| | 5.9.8 Open the vacuum line; |
| | 5.9.9 Close the bleed valve near the temperature probe; |
| | 5.9.10 Close the valve next to the pressure regulator inside the |
| | fume hood; |
| | 5.9.11 Close the nitrogen valve on the outside of the fume hood; |
| | and |
| | 5.9.12 Align the T-valve to only the vacuum line and round bottom |
| | vessel are connected |
| 5.36. | Allow the reaction to gently stir for 4 hours |
| 5.37. | Set the J-Kem to 70 degrees C. and break the vacuum with |
| | nitrogen |
| 5.38. | Add 3-5 wt % 20% citric acid solution and stir for 15-20 minutes |
| 5.39. | After the hold time, turn off the J-Kem and stirrer |
| 5.40. | Centrifuge the material at 4200 rpm for 10 minutes |
| 5.41. | Decant the liquid into a clean tared out round bottom flask and note |
| | the weight (avoid decanting the water, if possible) |
| 5.42. | Place the round bottom flask back into the refining/bleaching |
| | apparatus |
| 5.43. | Set the J-Kem to 60-65 degrees C. and, under gentle agitation, pull |
| | vacuum on the material |
| 5.44. | After 15 minutes, break the vacuum with nitrogen using procedure |
| | 5.6 |
| 5.45. | Add 0.5 wt % Trisyl and agitate for 15 minutes |
| 5.46. | Add 0.5 wt % Filter Aid and agitate for 5 minutes |
| 5.47. | Turn off the J-Kem and stirrer |
| 5.48. | Filter the material using a Buchner funnel, Erlenmeyer with |
| | sidearm, and Whatman #4 filter paper |
| 5.49. | Place the material into an appropriate labeled container and sparge |
| | with nitrogen prior to storage |

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of producing a interesterified oil, the method comprising:
providing sunflower oil comprising no more than about 4% total saturated fat; and
interesterifying the sunflower oil.

2. The method according to claim 1, wherein the sunflower oil comprises at least about 88% oleic acid (18:1).

3. The method according to claim 1, wherein the sunflower oil comprises less than about 3% palmitic acid (16:0).

4. The method according to claim 1, wherein interesterifying the sunflower oil comprises the use of a chemical catalyst.

5. The method according to claim 4, wherein the chemical catalyst is selected from the group consisting of alkali metals, alkalki metal alkylates, alkali metal hydroxides, alkali metal alcoholates, alkali metal alloys, Na/K alloys, sodium methoxide, sodium ethoxide, and sodium stearate.

6. The method according to claim 1, wherein interesterifying the sunflower oil comprises the use of an enzymatic catalyst.

7. The method according to claim 6, wherein the enzymatic catalyst is a lipase.

8. The method according to claim 6, wherein the enzymatic catalyst is a 1, 3 specific lipase.

9. An interesterified oil produced by the process of claim 1.

10. The interesterified oil according to claim 9, wherein at least 50% of the fatty acids at the 2 position of glycerol in the oil are unsaturated.

11. The interesterified oil according to claim 9, wherein at least 50% of the fatty acids at the 2 position of glycerol oil are oleic acid.

12. An interesterified sunflower oil wherein wherein at least 50% of the fatty acids at the 2 position of glycerol in the oil are unsaturated.

13. The interesterified sunflower oil of claim 12, wherein at least 50% of the fatty acids at the 2 position of glycerol in the oil are oleic acid.

14. A method of producing a interesterified oil, the method comprising:
providing sunflower oil comprising about 3.3% or less total combined palmitic acid (16:0) and stearic acid (18:0); and
interesterifying the sunflower oil.

15. The method of claim 14, wherein the oil content of the sunflower oil comprises combined palmitic acid (16:0) and stearic acid (18:0) of about or less than 3%.

16. The method according to claim 14, wherein the sunflower oil comprises at least about 90% oleic acid (18:1).

17. The method according to claim 14, wherein interesterifying the sunflower oil comprises the use of a chemical catalyst.

18. The method according to claim 1, wherein interesterifying the sunflower oil comprises the use of an enzymatic catalyst.

19. The method according to claim 6, wherein the enzymatic catalyst is a 1, 3 specific lipase.

20. An interesterified oil produced by the process of claim 14.
